(19) United States
(12) Patent Application Publication
(10) Pub. No.: US 2020/0396305 A1
(43) Pub. Date: Dec. 17, 2020

(54) METHOD AND SYSTEM FOR PROVIDING ACTIONABLE NOTIFICATION TO A USER OF AN AUGMENTED REALITY DEVICE

(71) Applicant: Samsung Electronics Co., Ltd., Gyeonggi-do (KR)

(72) Inventor: Naresh Kumar GUPTA, Noida (IN)

(73) Assignee: Samsung Electronics Co., Ltd.

(21) Appl. No.: 16/704,766

(22) Filed: Dec. 5, 2019

(30) Foreign Application Priority Data
Jun. 12, 2019 (IN) 201941023346

(51) Int. Cl. H04L 29/08; G06F 3/0482; H04L 12/58; G06F 3/0484; G06F 3/0481; G06F 3/0488; G06T 19/00

(52) U.S. Cl. CPC H04L 67/26; G06F 3/0482; H04L 51/24; G06F 3/04842; G06T 19/006; G06F 3/04817; G06F 3/0488; H04L 67/306; H04L 51/04

(57) ABSTRACT

An apparatus is provided. The apparatus includes a display; and at least one processor coupled to the display and configured to determine information concerning at least one object in a field of view of the apparatus, determine a relationship between the at least one object and a user of the apparatus, determine at least one notification concerning the at least one object based on the information and the relationship, wherein the at least one notification is displayed on the display, determine a user interface (UI) including at least one task based on the at least one notification, wherein the UI is displayed on the display, and perform the at least one task when the at least one task on the UI is selected.

### CROSS-REFERENCE TO RELATED APPLICATION(S)

This application is based on and claims priority under 35 U.S.C. § 119 to Indian Patent Application No. 201941023346, filed on Jun. 12, 2019, in the Indian Patent Office, the disclosure of which is incorporated by reference herein in its entirety.

### BACKGROUND

### 1. Field

The present disclosure relates to providing notification to a user and, more particularly, to a method and system for providing actionable notification to a user of an augmented reality (AR) device.

### 2. Description of the Related Art

AR and mixed reality (MR) technology provides information which is static in nature. The information provided by AR and MR technology is the same for all users of the AR devices. AR and MR do not provide a personalized notification or personalized information based on a user. Conventional AR and MR technology is unable to learn user behavior and provide information based on user behavior. Further, conventional AR and MR based methods for providing information to a user do not allow presenting actionable AR/MR information to the user. Further, conventional methods for providing AR/MR information to a user are controlled by a server and are based on a pre-defined information database.

Conventional AR/MR methods also do not relate to a system which may act as an interface between a user and another application in real time.

FIG. 1 is an illustration of a method for providing AR information 101 on a user's wearable device 100.

Referring to FIG. 1, the AR information 101 is provided on the user's wearable device 100 about a television (TV) that the user is watching. For example, the AR information 101 provided may be that the TV is ultra high definition (UHD) and has a dimension of 65″.

However, the AR information 101 provided is the same for all users of the wearable device 100. The method does not distinguish between the host of the device and another user using the wearable device 100. The method also does not disclose how to identify and show relational augmented information of the TV to a user based on the user's relationship to the TV.

Thus, it is desired to address the above-mentioned disadvantages or other shortcomings or at least provide a useful alternative.

### SUMMARY

An aspect of the present disclosure provides a method and system for providing actionable notification to a user of an AR device.

Another aspect of the present disclosure is to determine information about at least one object in a field of view of an AR device in an AR mode.

Another aspect of the present disclosure is to determine a relationship between a user of an AR device and at least one object.

Another aspect of the present disclosure is to determine at least one notification associated with at least one object to be augmented on an AR device based on information of the at least one object and a relationship between a user of the AR device and the at least one object.

Another aspect of the present disclosure is to generate at least one actionable user interface (UI) including at least one task to be performed based on at least one notification.

Another aspect of the present disclosure is to augment at least one actionable UI including at least one task to be performed corresponding to at least one notification in a field of view of an AR device in an AR mode.

Another aspect of the present disclosure is to detect at least one user action performed on at least one portion of at least one actionable UI augmented in a field of view of an AR device.

Another aspect of the present disclosure is to automatically perform at least one task based on a user input.

In accordance with an aspect of the present disclosure, an apparatus is provided. The apparatus includes a display; and at least one processor coupled to the display and configured to determine information concerning at least one object in a field of view of the apparatus, determine a relationship between the at least one object and a user of the apparatus, determine at least one notification concerning the at least one object based on the information and the relationship, wherein the at least one notification is displayed on the display, determine a UI including at least one task based on the at least one notification, wherein the UI is displayed on the display, and perform the at least one task when the at least one task on the UI is selected.

In accordance with an aspect of the present disclosure, a method of an apparatus is provided. The method includes determining information concerning at least one object in a field of view of the apparatus; determining a relationship between the at least one object and a user of the apparatus; determining at least one notification concerning the at least one object based on the information and the relationship, wherein the at least one notification is displayed on a display; determining a UI including at least one task based on the at least one notification, wherein the UI is displayed on the display, and performing the at least one task when the at least one task on the UI is selected.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an illustration of a wearable AR device providing information to the users;

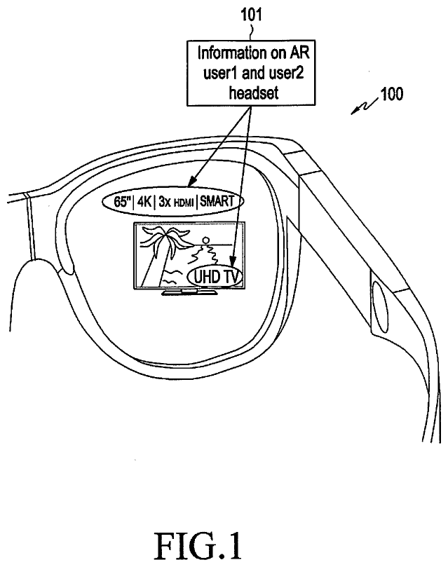

FIG. 2 is a block diagram of an AR device for providing actionable notification to a user of the AR device, according to an embodiment;

FIG. 3 is a block diagram of an actionable UI augmenter for providing actionable notifications to a user of an AR device, according to an embodiment;

FIG. 4 is a block diagram of an actionable UI augmenter for providing actionable notifications to a user of an AR device, according to an embodiment;

FIG. 5 is a block diagram of a personalized notification generator for providing actionable notifications to a user of an AR device, according to an embodiment;

FIG. 6 is a an illustration of an information aggregator for providing actionable notifications to a user of an AR device, according to an embodiment;

FIGS. 7A and 7B are a flow diagram of a method of providing actionable notification to a user of an AR device, according to an embodiment; and

FIG. 8 is an illustration of providing notification to a user based on a relationship, according to an embodiment.

### DETAILED DESCRIPTION

Embodiments of the present disclosure are described with reference to the accompanying drawings. Descriptions of well-known components and processing techniques are omitted so as to not unnecessarily obscure the present disclosure. In addition, various embodiments described herein are not necessarily mutually exclusive, as some embodiments may be combined with one or more other embodiments to form new embodiments. The term “or” as used herein, refers to a “non-exclusive or,” unless otherwise indicated. The examples used herein are intended merely to facilitate an understanding of ways in which the present disclosure may be practiced and to further enable those skilled in the art to practice the present disclosure. Accordingly, the examples are not intended to be construed as limiting the scope of the present disclosure.

The present disclosure may be described and illustrated in terms of blocks which carry out a described function or functions. These blocks, which may be referred to herein as “managers,” “units,” “modules,” “hardware components” or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor integrated circuits or chips, or on substrate supports such as printed circuit boards and the like. Circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the present disclosure may be physically separated into two or more interacting and discrete blocks without departing from the scope of the present disclosure. Likewise, blocks of the present disclosure may be physically combined into more complex blocks without departing from the scope of the present disclosure.

The accompanying drawings are intended to facilitate understanding of various technical features but it should be understood that the present disclosure is not intended to be limited by the accompanying drawings. As such, the present disclosure is intended to be construed to extend to any alterations, equivalents and substitutes in addition to those which are particularly set out in the accompanying drawings. Although the terms “first,” “second,” etc. may be used herein to describe various elements, these elements are not intended to be limited by these terms. These terms are generally only used to distinguish one element from another.

Accordingly, the present disclosure discloses a method for providing actionable notification to a user of an AR device. The method includes determining information about at least one object in a field of view of the AR device in an AR mode. The method further determines a relationship between the user of the AR device and the at least one object. The method further determines at least one notification associated with the at least one object to be augmented on the AR device based on the information of the at least one object and the relationship between the user of the AR device and the at least one object. The method also includes generating at least one actionable UI including at least one task to be performed based on the at least notification. The method further augments the at least one actionable UI including the at least one task to be performed corresponding to the at least notification in the field of the AR device in the AR mode.

Unlike conventional methods, a load balancer for a real-time operating system (RTOS) running on multiple processors (MP) minimizes energy consumption while maintaining an even or balanced computational load on multiple cores

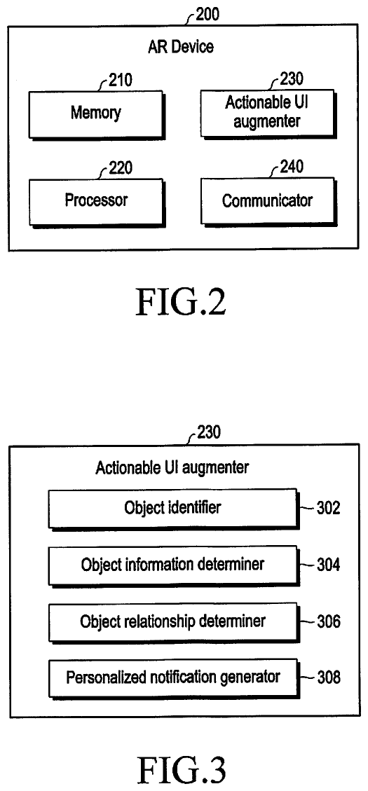

Referring to the accompanying drawings and, more particularly, to FIGS. 2-8 where similar reference characters denote corresponding features consistently throughout the figures, embodiments are shown.

FIG. 2 is a block diagram of an AR device 200 for providing actionable notification to a user of the AR device 200, according to an embodiment. The AR device 200 may be, for example, but is not limited to a smart social robot, a smart watch, a cellular phone, a smart phone, a personal digital assistant (PDA), a tablet computer, a head mounted smart device with a display, a laptop computer, a music player, a video player, an Internet of things (IoT) device or the like. The AR device 200 includes a memory 210, a processor 220, an actionable UI augmenter 230 and a communicator 240.

The processor 220 is coupled to the actionable UI augmenter 230, and the communicator 140. The processor 220 is configured to execute instructions stored in the memory 210 and perform various other functions.

In an embodiment, the user of the AR device 200 views a plurality of objects available in a field of view of the AR device 200 from the AR device 200. The plurality of objects in the field of view of the AR device 200 may be, for example, but is not limited to a smart refrigerator, a smartphone, a gas stove, a washing machine, an electronic device and the like.

The actionable UI augmenter 230 of the AR device 200 is configured to determine information about the plurality of objects in the field of view of the AR device 200 in the AR mode. In an embodiment, the information determined about the plurality of objects may be, for example, but is not limited to a pending TV bill, an email received on the smartphone of the user, a gas bill, an electricity bill and the like.

The actionable UI augmenter 230 is further configured to determine a relationship between the user of the AR device 200 and the plurality of objects. After determining the relationship between the user of the AR device 200 and the plurality of objects, the actionable UI augmenter 230 determines at least one notification associated with the plurality of object to be augmented on the AR device 200 based on the information of the plurality of objects and the relationship between the user of the AR device 200 and the plurality of objects. The actionable UI augmenter 230 is further configured to generate at least one actionable UI including at least one task to be performed based on the at least one notification. The actionable UI augmenter 230 augments the at least one actionable UI including the at least one task to be performed corresponding to the at least notification in the field of the AR device 200 in the AR mode.

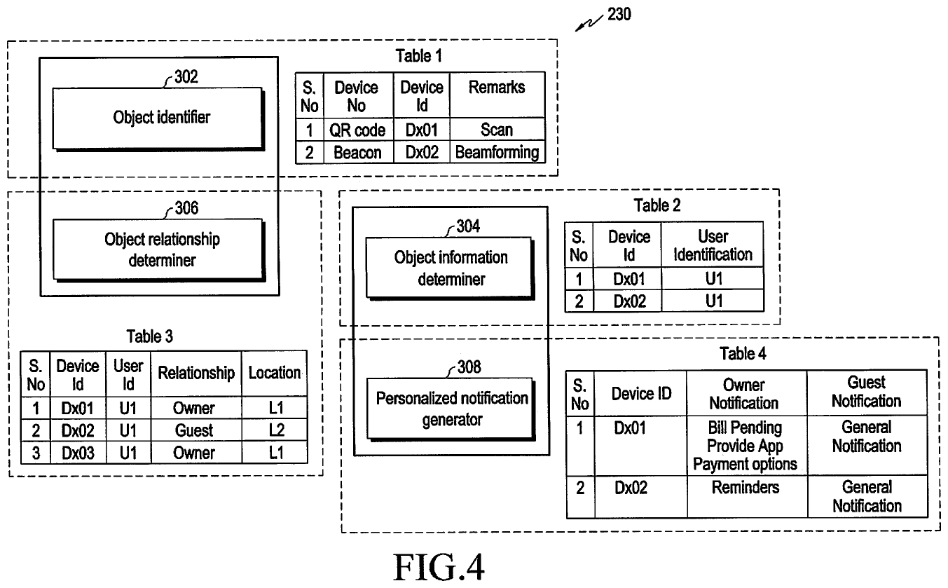

FIG. 3 is a block diagram of the actionable UI augmenter 230, according to an embodiment. The actionable UI augmenter 230 includes an object identifier 302, an object information determiner 304, an object relationship determiner 306 and a personalized notification generator 308. In an embodiment, the object identifier 302 identifies objects in a field of view of the AR device 200 in an active mode. The object information determiner 304 determines information about the identified objects.

In an embodiment, the object information determiner 304 scans a unique code associated with the at least one object and the object information determiner 304 determines the information about the identified objects based on the unique code. The information of the identified objects may also be obtained by sending a beacon signal to the at least one object and obtaining a response including the information about the least one object. In an embodiment, the information may be obtained by other methods. In another embodiment, the information may be obtained by comparing a unique identifier of the user with at least one unique identifier of the at least one object and obtaining the information about at least one object based on the unique identifier of the user matching the at least one unique identifier of the at least one object. In another embodiment, the information may be obtained from a network system associated with the AR device 200 and the at least one object.

After determining the information of the at least one object, the object relationship determiner 306 determines a relationship between the user of the AR device 200 and the plurality of objects. In an embodiment, the object relationship determiner 306 determines whether the user of the AR device 200 is also a user of the at least one object by authenticating the user using an authentication parameter. The authentication parameter may be, for example, but is not limited to a user biometric, a unique identifier associated with the user, a location of the user, profile data of the user, and user social activities of the user.

If authentication of the user is successful then the user of the AR device 200 is determined to also be a user of the at least one object. The object relationship determiner 306, upon successful authentication of the user, identifies the relationship between the user of the AR device 200 and the at least one object and marks the user of the AR device 200 as a host user. If authentication of the user is unsuccessful then the user of the AR device 200 is determined to be different than the user of the at least one object. After an unsuccessful authentication of the user, the object relationship determiner 306 identifies the relationship between the user of the AR device 200 and the at least one object and marks the user of the AR device 200 as a guest user.

In an embodiment, the AR device 200 is communicatively coupled to an IoT based block-chain network. The AR device 200 creates a block-chain based pre-registered relationship matrix by analyzing the user's activities across the plurality of objects in an IoT based block-chain network. The block-chain based pre-registered relationship matrix includes data about the relationship between the plurality of objects and the user of the AR device 200. The object relationship determiner 306 sends a user identifier and an identifier associated with the at least one object to the block-chain based pre-registered relationship matrix for determining the relationship between the at least one object and the user of the AR device 200. If authentication of the user is determined to be successful by the block-chain based pre-registered relationship matrix then the user of the AR device 200 is determined to also be the user of the at least one object. The object relationship determiner 306 then identifies the relationship between the user of the AR device 200 and the at least one object and marks the user of the AR device 200 as a host user.

If authentication of the user is determined to be unsuccessful by the block-chain based pre-registered relationship matrix then the user of the AR device 200 is determined to be different than the user of the at least one object. The object relationship determiner 306 then identifies the relationship between the user of the AR device 200 and the at least one object and marks the user of the AR device 200 as a guest user.

After determining the relationship between the user of the AR device 200 and the at least one object, the personalized notification generator 308 determines notifications associated with the at least one object to be augmented on the AR device 200. The notification to be augmented on the AR device 200 is based on the information of the at least one object and the relationship between the user of the AR device 200 and the at least one object. After determining the notification, the personalized notification generator 308 determines a context of the at least one notification associated with the at least one object. The context of the at least one notification is determined based on a content of the at least one notification and the information about the at least one object. The personalized notification generator 308 identifies at least one task to be performed based on the context of the at least one notification. The personalized notification generator 308 then generates at least one actionable UI including the at least one task to be performed. The at least one notification includes curating at least one notification across objects based on the information of the at least one object and the relationship between the user of the AR device 200 and the at least one object.

In an embodiment, an actionable UI may include actions to be performed by the AR device 200 based on the user's input. For example, the actionable UI may include options relating to a bill payment method. The options may include different types of the bill payment method such as PAY™, unified payments interface (UPI) and the like.

In an embodiment, the AR device 200 detects at least one user input on the at least one actionable UI augmented in the field of view of the AR device 200. The user in the above example may select PAY™ for paying the bill. Thus, the user's input in the example is PAY™. After obtaining the user's input, the AR device 200 performs at least one task based on the user's input. In the above example, the task performed by the user is bill payment via PAY™.

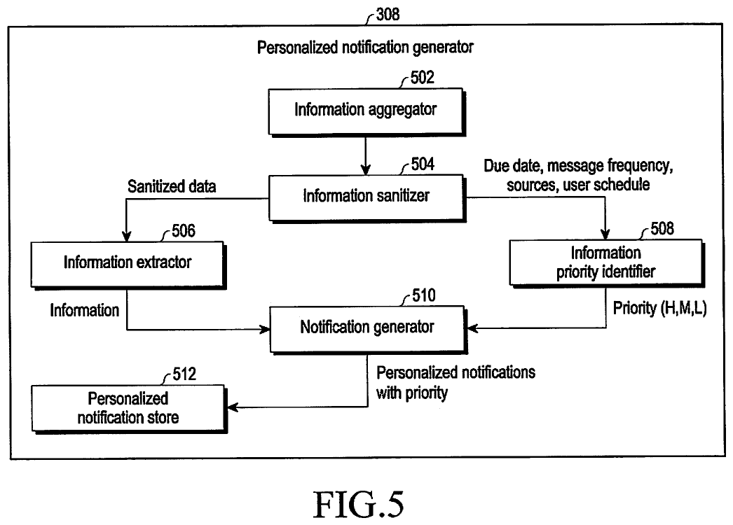

FIG. 4 is a block diagram of the actionable UI augmenter 230 according to an embodiment of the present disclosure.

Referring to FIG. 4, Table 1 corresponds to the object identifier 302. As described above, the object identifier 302, identifies objects in the field of view of the AR device 200. Table 1 indicates the object identification, the object identifier (ID) and remarks. In an embodiment, the object identifier 302 represents the method used to identify the object. As seen in Table 1, an object 1 is to be identified by scanning a quick response (QR) code. Similarly, object 2 is to be identified using a beacon signal. Column “Device Id” indicates the identifier associated with the identified object. The “Remarks” column indicates status. As seen in Table 1, for object 1, the Remarks column indicates that the QR code is scanned. Similarly, for object 2, the Remarks column indicates that a beam is being formed.

Referring to FIG. 4, Table 2 corresponds to the object information determiner 304. The object information determiner 304 determines the information associated with the identified objects. Table 2 includes a “Device Id” column and a “User Identification” column. The “Device Id” column indicates the ID of the object and the “User Identification” indicates an authentication parameter associated with the user of the AR device 200.

Table 3 corresponds to the object relationship determiner 306. The object relationship determiner 306 determines the relationship of the object with the user of the AR device 200. Table 3 includes a “Device Id” column, a “User Id” column, a “Relationship” column, and a “Location” column. The “Device Id” column indicates the ID of the object and the “User Id” column indicates an authentication parameter associated with the object. The “Relationship” column indicates the relationship between the object and the user. The “Location” column indicates the location of the object with respect to the user.

Table 4 corresponds to the personalized notification generator 308. The personalized notification generator 308 generates a personalized notification for the user of the AR device 200 corresponding to the identified object and the determined relationship with the user of the AR device 200. Table 4 includes “User Identification”, “Owner, Notification”, and “Guest Notification” columns. The “Guest Notification” column indicates the notification generated for the user identified as a guest and the “Owner Notification” column indicates the personalized notification generated for the user identified as the host.

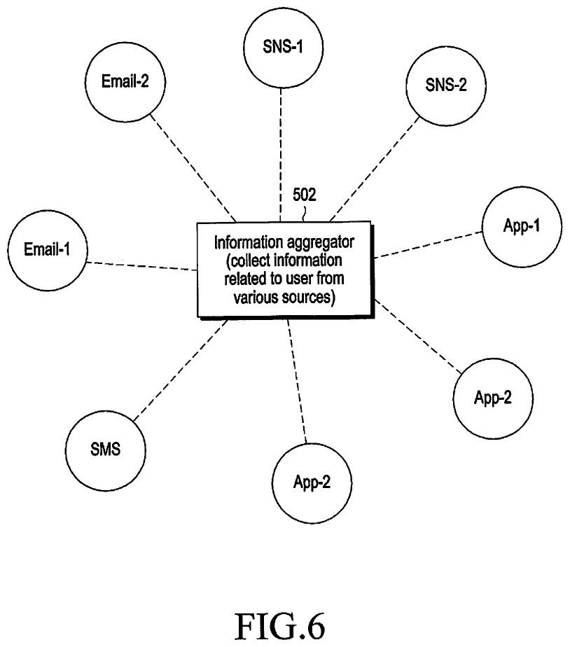

FIG. 5 is a block diagram of the personalized notification generator 308 for providing notification to the user of the AR device 200.

Referring to FIG. 5, the notification generator 308 includes an information aggregator 502, an information sanitizer 504, an information extractor 506, an information priority identifier 508, a notification generator 510 and a personalized notification store 512.

The information aggregator 502, collects and aggregates information from a plurality of sources corresponding to a user of the AR device 200. The aggregated information is then sent to the information sanitizer 504 in a tabulated form. The information sanitizer 504 identifies whether the information is repeated or if some information is missing in a particular field and sanitizes the tabulated information received from the information aggregator 502 and inputs the information in the correct field. Information sanitizing helps to avoid repetition of information and also checks for redundant information received from multiple sources.

The information priority identifier 508 identifies data received from the information sanitizer 504 and prioritizes the information based on the context and content of the information.

The information extractor 506 identifies relevant information from a message and fills the information into a particular field.

The notification generator 510 generates a notification for the user of the AR device 200 based on the input received from the information extractor 506 and the information priority identifier 508.

The personalized notification store 512 receives personalized notifications with priority from the notification generator 510.

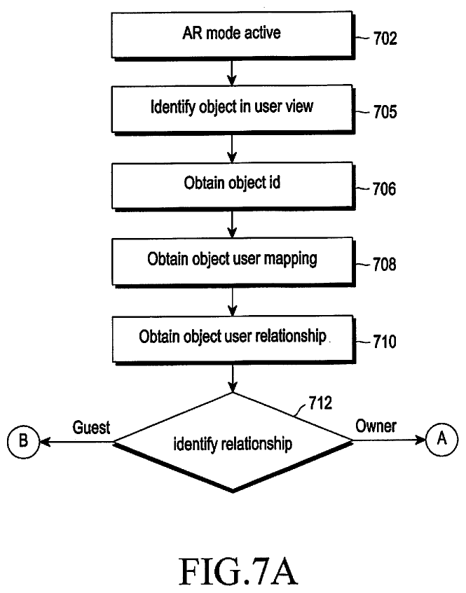

FIG. 6 is an illustration of the information aggregator 502.

Referring to FIG. 6, the information aggregator 502 collects information from various available sources. The various available sources may relate to but are not limited to an email received by a user, a short message service (SMS) received by the user, an application used by the user and the like. Table 5 below is an example of an information aggregation table. The information aggregator 502 collects information from available sources and provides tabulated data as shown in Table 5 below. Table 5 below includes a source from which data is obtained, a date related to the information, and data related to the information. As illustrated in FIG. 6, the first entry in Table 5 below is obtained from an email-1 received by the user. Table 5 below provides data about the type of information obtained from email-1 such as a pending bill payment. Table 5 below also provides a due date and an amount of the pending bill. Further, Table 5 below also provides information data about the bill such as the pending bill is from a company named KEPCO. Thus, the information aggregator 502 collects information from the available sources and provides the information in a tabulated form to the information sanitizer 504. In an embodiment, the aggregation table may include other data related to the source and the information obtained from the source.

TABLE 5

| | | Information | | Information |
|---|---|---|---|---|
| S. No. | Source | type | Date/Time | data |
| 1. | Email-1 | Bill | May 12, | KEPCO, |
| | | Payment | 2019 | April-2019 |
| | | | 13:00:00 | bill, $8.56; |
| | | | | MeterID |
| 2. | App-2 | Data usage | May 11, | SK Tel, Buy |
| | | notification | 2019 | more data, |
| | | | 04:00:00 | Broadband |
| | | | | Device ID |
| 3. | SMS | Bill | May 10, | KEPCO, |
| | | Payment | 2019 | April-2019 |
| | | | 11:00:00 | bill, $8.56 |

Table 6 below is an example of an information sanitizing table. Table 6 below provides further information on the contents of Table 5 above. For example, as shown in Table 6 below, the sanitizer 504 provides information such as a service provider for paying a pending bill as shown in Table 5 above. In an embodiment, the information sanitizing table may include other data related to a source and information obtained from the source.

TABLE 6

| | Service | Information | Due | Information | |
|---|---|---|---|---|---|
| S. No. | provider | type | Date/Time | data | Sources |
| 1 | KEPCO, | Bill | May 15, | W $8.56 | Email-1 |
| | MeterID | Payment | 2019 | | SMS |
| 2 | SK Tel, | Data usage | May 10, | $17.12 | App-2 |
| | Broadband | | 2019 | | |
| | Device ID | | | | |

Table 7 below is an example of an information priority identifier table. Table 7 below indicates a priority associated with information collected from available sources. As shown in Table 7 below, a frequency of the information obtained from the various sources is indicated. Based on the frequency of the information, the priority is determined by the information priority identifier 508. In an embodiment, the priority may be determined based on other parameters. In an embodiment, the information priority identifier table may include other data related to the source and the information obtained from the source.

TABLE 7

| | Service | Message | | Due | |
|---|---|---|---|---|---|
| S. No. | provider | Frequency | Sources | Date/Time | Priority |
| 1. | KEPCO, | 2 | Email-1 | May 15, | High |
| | MeterID | | SMS | 2019 | |
| 2. | SKTel, | 2 | App-2 | May 10, | High |
| | Broadband | | | 2019 | |
| | Device ID | | | | |

Table 8 below is an example of an information extractor table. The information extractor table provides particular data to be in the correct field. As seen in Table 8 below, a cost of a bill is included under an “Amount” column.

TABLE 8

| | Service | | Due |
|---|---|---|---|
| | provider | Amount | Date/Time |
| 1. | KEPCO, MeterID | $0.86 | May 15 |
| | | | 2019 |
| 2. | SKTel, | $1.72 | May 10, |
| | Broadband | | 2019 |
| | Device ID | | |

In an embodiment, the information extractor table may include other data related to the source and the information obtained from the source.

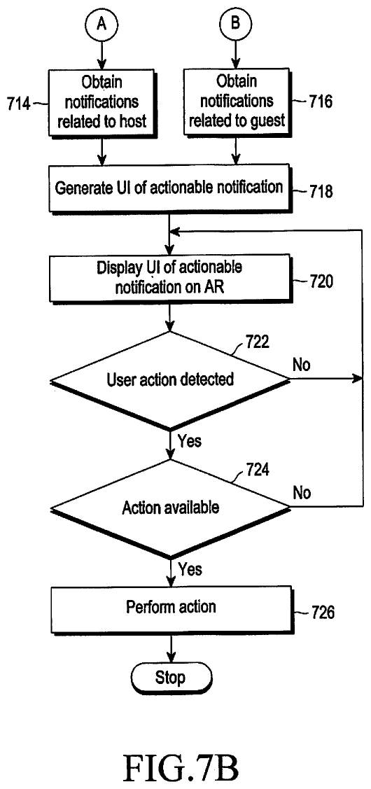

FIGS. 7A and 7B are a flow diagram of a method for providing actionable notification to a user of the AR device 200.

Referring to FIGS. 7A and 7B, at 702, the AR device 200 is determined to be in active mode. At 705, the AR device 200 identifies at least one object in a field of view of the AR device 200. At 706, the AR device 200 obtains an identifier associated with the at least one object. At 708, the AR device 200 maps the identifier associated with the at least one object with user data. At 710 the AR device 200 compares the identifier associated with the at least one object with parameters associated with the user.

At 712, the AR device 200 determines a relationship between the user and the at least one object. The relationship between the user and the at least one object may be identified as a guest or a host. At 714, the AR device 200 obtains notifications related to the at least one object based on the relationship identified as the host. At 716, the AR device 200 obtains notifications related to the at least one object based on the relationship identified as the guest. At 718 the AR device 200 generates a UI including an actionable notification for the user. At 720, the AR device 200 displays the UI including the actionable notification to the user for performing an action. At 722 the AR device 200, determines whether a user action is detected or not. If the user action is detected then the flow diagram proceeds to 724. If the user action is not detected, then the flow diagram goes back to 720. At 724, the AR device 200 determines whether a task is available to be performed based on the user action. If the task is available to be performed then the flow diagram proceeds to 726. If the task is not available to be performed, then the flow diagram goes back to 720. At 726, the AR device 200 performs the task selected by the user.

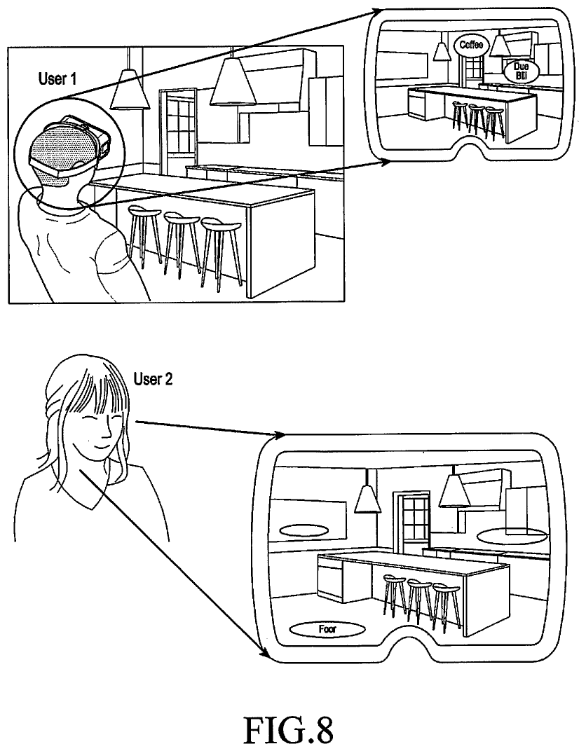

FIG. 8 is an illustration of providing a notification to a user based on a relationship, according to an embodiment.

Referring to FIG. 8, a first user (e.g., user 1) is a host user and a second user (e.g., user 2) is a guest user. User 1 is using the AR device 200. User 1 is viewing a kitchen area through the AR device 200. The objects in a field of view of the AR device 200 are a kitchen chimney, a coffee maker, a gas cylinder and the like. The AR device 200 identifies the objects in the field of view and determines information related to the identified objects. Further, the AR device 200 obtains user data such as a biometric scan and compares a user identifier with the information about the objects. The AR device 200 then determines a relationship between user 1 and the objects and marks user 1 as a host user. The AR device 200 performs the same steps for user 2, and identifies user 2 as a guest user. After identifying the relationship between the users, the AR device 200 generates an actionable UI for user 1 since user 1 is the host user. The actionable UI generated for user 1 is different from what is shown to user 2. The AR device 200 does not provide any information in the current scenario about the identified objects to user 2 since user 2 is the guest user.

In an embodiment, the AR device 200 may provide a notification to user 2 based on the identified objects.

The embodiments disclosed herein may be implemented using at least one software program running on at least one hardware device and performing network management functions to control the elements.

The foregoing description of the embodiments of the present disclosure so fully reveal the general nature of the embodiments herein that others may, by applying current knowledge, readily modify and/or adapt for various applications such embodiments without departing from the scope of the present disclosure, and, therefore, such adaptations and modifications are intended to be within the scope of the present disclosure. It is to be understood that the terminology employed herein is for the purpose of description and not of limitation. Therefore, while embodiments herein are described, those skilled in the art will recognize that the embodiments herein may be practiced with modification within the scope of the present disclosure as defined by the appended claims and their equivalents.

What is claimed is:

1. An apparatus, comprising:
a display; and
at least one processor coupled to the display and configured to:
determine information concerning at least one object in a field of view of the apparatus,
determine a relationship between the at least one object and a user of the apparatus,
determine at least one notification concerning the at least one object based on the information and the relationship, wherein the at least one notification is displayed on the display,
determine a user interface (UI) including at least one task based on the at least one notification, wherein the UI is displayed on the display, and
perform the at least one task when the at least one task on the UI is selected.

2. The apparatus of claim 1, wherein the at least one processor comprises:
an object identifier configured to identify the at least one object;
an object information determiner configured to determine the information concerning the at least one object;
an object relationship determiner configured to determine whether the user is a user of the at least one object; and
a personalized notification generator configured to determine the at least one notification and the UI including the at the least one task.

3. The apparatus of claim 2, wherein the object identifier is further configured to store an identifier and a status for each identified object.

4. The apparatus of claim 2, wherein the object information determiner is further configured to store an identifier for each identified object and an identifier of the user.

5. The apparatus of claim 2, wherein the object relationship determiner is further configured to store an identifier for each identified object, an authentication parameter for each identified object, a relationship between each identified object and the user, and a location of each identified object with respect to the user.

6. The apparatus of claim 2, wherein the personalized notification generator is further configured to store an identifier for each identified object; at least one first type of notification associated with each identified object, respectively, concerning the user; and at least one second type of notification associated with each identified object, respectively, concerning the user.

7. The apparatus of claim 2, wherein the personalized notification generator comprises:
an information aggregator configured to collect and aggregate information from a plurality of sources corresponding to the user;
an information sanitizer coupled to the information aggregator and configured to remove redundancy from the collected information and identify an omission in the collected information;
an information extractor coupled to the information sanitizer and configured to identify and store relevant information from a message;
an information priority identifier coupled to the information sanitizer and configured to prioritize information based on context and content;
a notification generator coupled to the information extractor and the information priority identifier and configured to generate a notification for the user; and
a storage device coupled to the notification generator and configured to store a personalized notification and a priority of the personalized notification.

8. The apparatus of claim 7, wherein the plurality of sources corresponding to the user comprises at least one of an electronic mail, a short message service message, and an application.

9. The apparatus of claim 1, wherein the at least one processor is further configured to performing the at least one task when the at least one task on the UI is selected and the task is available to be performed.

10. The apparatus of claim 1, further comprising:
a memory coupled to the at least one processor and configured to store the information;
a processor coupled to the memory and configured to perform various functions; and
a communication device coupled to the processor and configured to establish a communication with an external device.

11. A method of an apparatus, comprising:
determining information concerning at least one object in a field of view of the apparatus;
determining a relationship between the at least one object and a user of the apparatus;
determining at least one notification concerning the at least one object based on the information and the relationship, wherein the at least one notification is displayed on a display;
determining a user interface (UI) including at least one task based on the at least one notification, wherein the UI is displayed on the display, and
performing the at least one task when the at least one task on the UI is selected.

12. The method of claim 11, further comprising:
identifying the at least one object;
determining the information concerning the at least one object;
determining whether the user is a user of the at least one object; and
determining the at least one notification and the UI including the at the least one task.

13. The method of claim 12, further comprising storing, by the object identifier, an identifier and a status for each identified object.

14. The method of claim 12, further comprising storing, by the object information determiner, an identifier for each identified object and an identifier of the user.

15. The method of claim 12, further comprising storing, by the object relationship determiner, an identifier for each identified object, an authentication parameter for each identified object, a relationship between each identified object and the user, and a location of each identified object with respect to the user.

16. The method of claim 12, further comprising storing, by the personalized notification generator, an identifier for each identified object; at least one first type of notification associated with each identified object, respectively, concerning the user; and at least one second type of notification associated with each identified object, respectively, concerning the user.

17. The method of claim 12, further comprising:
collecting and aggregating, by an information aggregator included in the personalized notification generator, information from a plurality of sources corresponding to the user;
removing, by an information sanitizer included in the personalized notification generator and coupled to the information aggregator, redundancy from the collected information and identifying an omission in the collected information;
identifying and storing, by an information extractor included in the personalized notification generator and coupled to the information sanitizer, relevant information from a message;
prioritizing, by an information priority identifier included in the personalized notification generator and coupled to the information sanitizer, information based on context and content;
generating, by a notification generator included in the personalized notification generator and coupled to the information extractor and the information priority identifier, a notification for the user; and
storing, by a storage device included in the personalized notification generator and coupled to the notification generator, a personalized notification and a priority of the personalized notification.

18. The method of claim 17, wherein the plurality of sources corresponding to the user comprises at least one of an electronic mail, a short message service message, and an application.

19. The method of claim 11, further comprising performing the at least one task when the at least one task on the UI is selected and the task is available to be performed.

20. The method of claim 11, further comprising:
storing the information;
performing various functions by a processor coupled to the memory; and
establishing, by a communication device coupled to the processor, a communication with an external device.
